(19) United States
(12) Patent Application Publication
(10) Pub. No.: US 2018/0136626 A1
(43) Pub. Date: May 17, 2018

(54) SYSTEM AND METHOD FOR COMPENSATING MULTI-AXIS MANUFACTURING SYSTEMS

(71) Applicant: GM GLOBAL TECHNOLOGY OPERATIONS LLC, Detroit, MI (US)

(72) Inventors: Jie Gu, Clarkston, MI (US); John S. Agapiou, Rochester Hills, MI (US)

(73) Assignee: GM GLOBAL TECHNOLOGY OPERATIONS LLC, Detroit, MI (US)

(21) Appl. No.: 15/349,464

(22) Filed: Nov. 11, 2016

(51) Int. Cl. G05B 19/402

(52) U.S. Cl. CPC G05B 19/402; G05B 2219/41188; G05B 2219/36568; G05B 2219/34319

(57) ABSTRACT

A computer controlled machining system is provided, and includes a multi-axis machining device that is configured to produce a workpiece based on a part print, which outlines nominal dimensions for the workpiece. A dimensional measuring device is configured to take or determine measured dimensions of the workpiece. A compensation processor is configured to take the measured dimensions from the dimensional measuring device and compare them to the nominal dimensions, and to determine a plurality of deviation sets from such comparison. The compensation processor transfers the deviation sets to the multi-axis machining device, which shifts a machine coordinate system based on the deviation sets.

### INTRODUCTION

The present disclosure relates generally to a system and method for calculating and implementing global and local compensation for multi-axis computer controlled manufacturing systems. Computer numerical controlled (CNC) machining systems, and other computer controlled systems, such as robotics, may be used in industrial settings to accurately machine workpieces according to previously defined plans. Often these plans are developed in a computer aided design package, and may be represented in the form of engineering drawings or part prints. A CNC machine may operate according to an assembled sequence of commands (e.g., G-code) that instruct the system to machine a part by moving a controllable cutting tool. During the operation, the system may monitor the real-time position of the workpiece and tool, and may control its position relative to the workpiece via servomotor control.

### SUMMARY

A computer controlled machining system is provided. The machining system includes a multi-axis machining device that is configured to produce a workpiece based on a part print, which outlines nominal dimensions for the workpiece.

A dimensional measuring device is configured to take measured dimensions of the workpiece. A compensation processor is configured to take the measured dimensions from the dimensional measuring device and compare them to the nominal dimensions, and to determine a plurality of deviation sets from such comparison. The compensation processor transfers the deviation sets to the multi-axis machining device, which shifts a machine coordinate system based on the deviation sets.

In some configurations, the compensation processor calculates a plurality of compensation variables from the deviation sets, and transfers the compensation variables to the multi-axis machining device. In such a configuration, the multi-axis machining device shifts the machine coordinate system based on the compensation variables.

In some configurations, the compensation processor may be configured to transfer the compensation variables to the multi-axis machining device via registers in G-Code programming of the multi-axis machining device. Some configurations may have nine compensation variables, but fewer or additional compensation variables may be incorporated.

The above features and advantages and other features and advantages of the present structures, methods, or both, are readily apparent from the following detailed description of the best modes and other embodiments for carrying out the described methods, structures, and processes, when taken in connection with the accompanying drawings.

### BRIEF DESCRIPTION OF THE DRAWINGS

FIG. 1 is a schematic diagram of a system for compensating the dimensional accuracy of a machined part.

FIG. 2 is a schematic top view of a part or workpiece produced to a part print having a plurality of features.

FIG. 3 is a schematic perspective view of a dimensional measuring device, which is a coordinate measuring machine (CMM).

FIG. 4 is a schematic perspective view of a 5-axis, A-on-B CNC mill, which is one embodiment of a multi-axis manufacturing system or tool usable with the methods described herein.

FIG. 5 is a schematic diagram of a plurality of reference coordinate systems within a CNC machining system.

FIG. 6 is a flow diagram of an embodiment of a computerized algorithm or method for electronically compensating a multi-axis manufacturing system from dimensional measurement data.

FIG. 7A is a schematic perspective view of a 6-axis machine, which is an A-on-B table CNC mill with a rotatable spindle, and is usable with the methods described herein.

FIG. 7B a schematic perspective view of a 7-axis machine, which is a C-on-B table CNC mill with a spindle rotatable about two axes, and is usable with the methods described herein.

FIG. 7C a schematic perspective view of a 6-axis machine, which is a lathe mill having a two-axis spindle, and is usable with the methods described herein.

FIG. 7D a schematic perspective view of a multi-axis robot, which is usable with the methods described herein.

### DETAILED DESCRIPTION

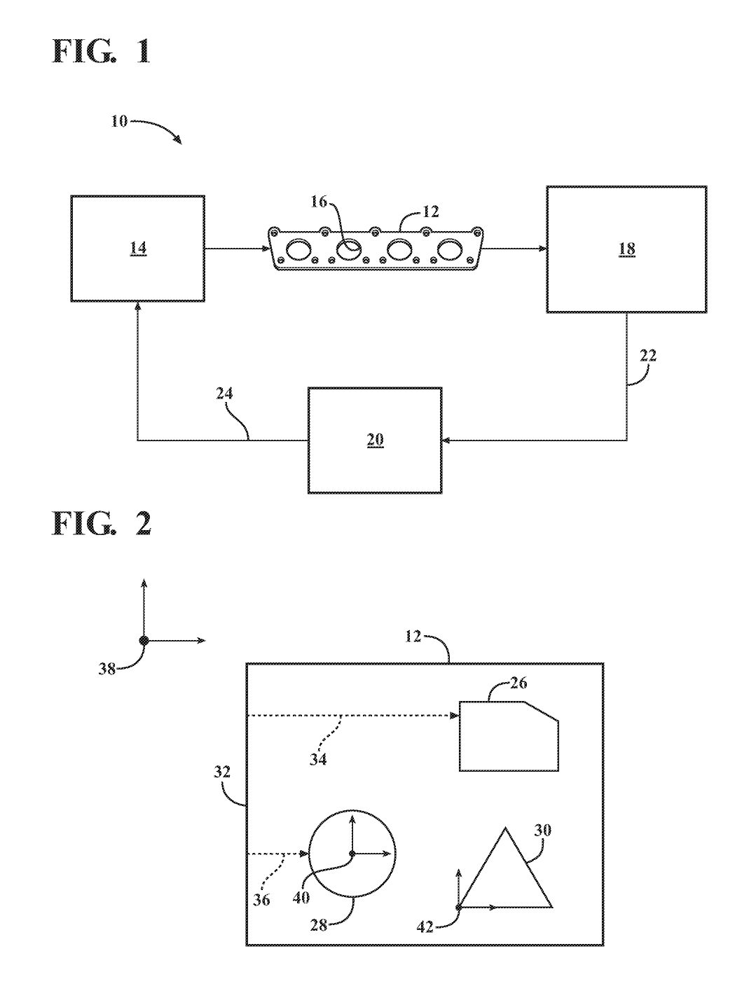

Referring to the drawings, like reference numerals are used to identify generally similar components, wherever possible, in the various views. FIG. 1 illustrates an exemplary system 10 for compensating the dimensional accuracy of a machined workpiece 12.

As shown, the system 10 may include a computer controlled manufacturing tool 14, which may be, for example, a computer numerical controlled (CNC) machining system or tool or a robot. The manufacturing tool 14 creates one or more features 16, such as a hole, on the workpiece 12 through one or more machining processes.

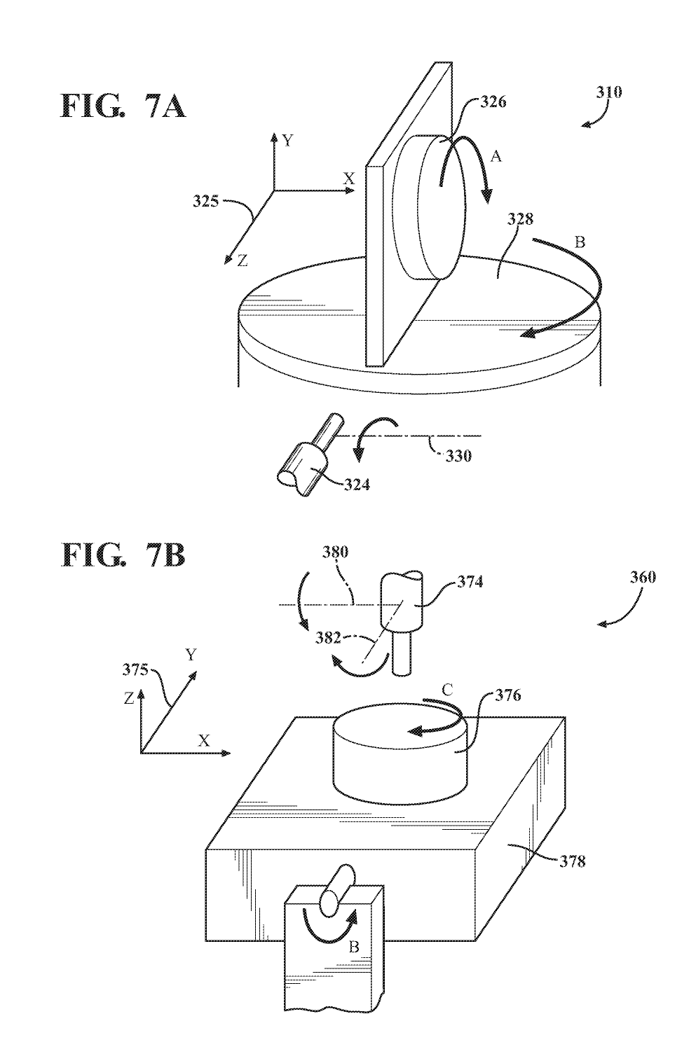

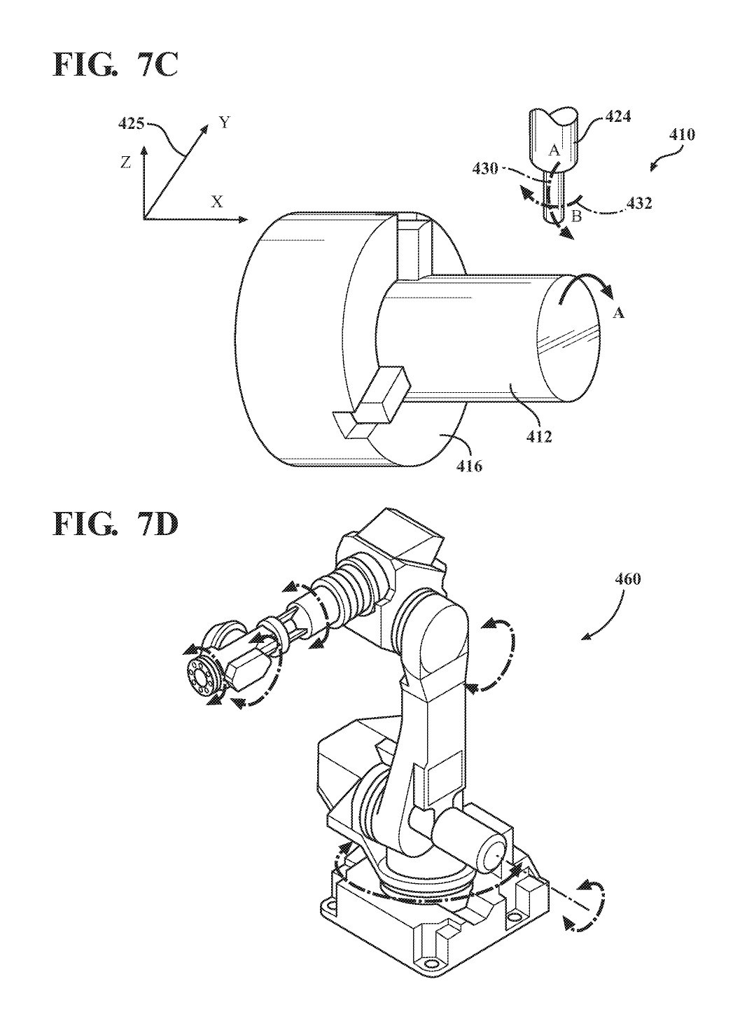

As illustrated herein with respect to FIGS. 4 and 7A-7D, the manufacturing tool 14 is representative of numerous types of devices and systems. In exemplary embodiments, the manufacturing tool 14 may be a 5-axis CNC mill or a 7-axis manufacturing robot. The manufacturing tool 14 may perform processes including, but not limited to, cutting, face milling, boring, honing, drilling, or welding, to create the workpiece 12.

The workpiece 12 is produced by the manufacturing tool 14 based on a part print, which may be a two or three-dimensional engineering drawing or engineering model. The part print used to create the workpiece 12 is representative of a single set of design characteristics, often represented by a single part number. Some or all of the design characteristics are implemented by the manufacturing tool 14, or a combination of multiple systems, on a plurality of workpieces 12. In general, as used herein, a part is a set of design characteristics represented by the part print, and a workpiece is an individual instance of material being transformed by the manufacturing tool 14 into a physical representation of the part. Several workpieces 12 may progress successively through the manufacturing tool 14 tasked with creating the part.

In production environments, a plurality of manufacturing systems or manufacturing tools 14 may be used to (substantially simultaneously) process multiple workpieces 12, such that there are a plurality of parallel lines producing the workpiece 12 based on a common, or substantially common, part print.

Once the one or more features 16 are machined into one or more of the workpieces 12, a dimensional measuring device, such as a coordinate measuring machine or CMM 18 may measure one or more dimensions of one or more of the resulting workpieces 12. Each measured dimension may be taken with respect to an established datum or control surface that may be specified in the corresponding part print of the workpiece 12. The engineering drawing may specify a nominal dimension for each measurement, and may further provide acceptable tolerances.

Furthermore, each manufacturing tool 14 may be capable of producing a plurality of different workpieces 12 from different part prints having different sets of design characteristics and different features. Furthermore, each manufacturing tool 14 may also be configured to produce multiple variations of the workpiece 12.

The system 10 may further include a compensation processor 20 that is configured to receive part measurement data 22 from the CMM 18, and to compute one or more compensation variables 24, such as global offsets and local offsets. The compensation processor 20 may include, for example and without limitation, a COMP (Capability Optimization for Machining Process) software package that may aid in computing the one or more compensation variables 24. Determination of the compensation variables 24 is described in further detail herein. Once computed, the compensation variables 24 may be loaded into the manufacturing tool 14 to enhance the dimensional accuracy of the machining process.

The compensation processor 20, the CMM 18, the manufacturing tool 14, and any other computers or control systems utilized herein are configured with sufficient computational resources and components to execute the methods and techniques described herein, in addition to other related functions. For example, the compensation processor 20, the CMM 18, and the manufacturing tool 14 include sufficient memory, processing, and communication capabilities to perform all calculations, data processing, and machine control to produce the workpieces 12 and compensate the manufacturing tool 14 based thereupon. Additional computational devices may be incorporated within the system 10, which includes sufficient hardware and software to execute the methods, processes, and algorithms described herein and any additional method, processes, or algorithms recognizable to skilled artisans.

As generally illustrated in FIG. 2, the workpiece 12 may include a plurality of features including a first cavity 26, a second cavity 28, and a third cavity 30, which may individually or collectively be referred to features 16. Each feature may be machined by a manufacturing tool 14 according to an engineering drawing. Exemplary features may include, without limitation, holes, bores, channels, and/or machined faces. Each machined feature may be positioned with respect to one or more datum or control surfaces. For example, the distance between the first cavity 26 and an edge 32 may define a first dimension 34. Similarly, the distance between the second cavity 28 and the edge 32 may define a second dimension 36.

The CMM 18 produces measurement data from the workpiece 12. When a dimension of one or more machined features (e.g., such as the dimension 34 or the dimension 36) deviates from the nominal dimensions provided in the part print, the compensation processor calculates deviation sets based on the differences between the nominal dimensions and the measured dimensions.

The compensation variables 24 provided by the compensation processor 20 may modify the machining process and attempt to reduce the deviation. In many CNC machining systems, part errors are compensated by mechanically adjusting componentry of the machine. The machine may be mounted on tracks and movable via rotation of adjustment screws, such that an error in which dimension A is off by 0.02% in x-direction is mechanically compensated by turning a specific screw until some portion of the machine slides 0.02% of dimension A in the opposite direction.

However, these mechanical adjustments may not be easy to implement on the machine, such that regular adjustment is impractical. The mechanical adjustments may also apply to large portions, if not the entirety, of the machine. Additionally, individual components may not be individually mechanically adjustable. For example, if the x-axis of an A-table in a 5-axis A-on-B mill needs 0.01 inches of adjustment, the only option for mechanical adjustment may be to move the x-axis of the B-table upon which the A-table sits, which may result in additional, undesirable offsets to the B-table.

Contrarily, the system 10 is configured for electronic compensation, as opposed to mechanical adjustment. The system 10 can selectively, electronically shift a multitude of coordinate systems and a multitude of individual axes, without altering any other coordinate systems or axes. Using the example above, if the A-table needs its x-axis adjusted by 0.01 inches, the system 10 can instruct the manufacturing tool 14 to electronically shift the coordinate system of only the A-table by 0.01 inches along its x-axis.

Electronic compensation of the manufacturing tool 14 is illustrated by Equation 1, which unifies part errors with electronic shifts that correct for part errors.

Δ\acute{M}_{cmm}=Δ\acute{M}_{global}_{_}_{feature}_{_}ₗᵢₙₑₐᵣ+Δ\acute{M}_{global}_{_}_{feature}_{_}_{angular} Equation 1

The left side of Equation 1 represents deviations measured by the CMM 18 on one or more of the workpieces 12 relative to the part print specifications for features 16. The right side of Equation 1 represents the (linear and angular) electronic shifts implemented by the manufacturing tool 14 to compensate for those errors. When the right side of Equation 1 is equal to the left side, the manufacturing tool 14 is electronically compensating for any physical errors of the machine tool 14 or components thereof that contribute to creation of the workpieces 12. This electronic compensation may remove any need for, and be more precise than, mechanical adjustment of the manufacturing tool 14.

In an embodiment, the compensation variables 24 include two types of offsets that may be used to reduce deviations: global offsets and local offsets (note that both may be concurrently available and implemented). A global offset may adjust the origin and/or orientation of a machine coordinate system 38, which is the non-moving, base, coordinate system that defines the relationship of all other components, including rotating or moving tables or spindles, relative to the manufacturing tool 14 itself. The workpiece 12, or the part print upon which the workpiece 12 is based, is related to the machine coordinate system 38 by a part coordinate system 40.

The features 16, such as the first cavity 26, the second cavity 28, and the third cavity 30, may be dimensioned or located relative to the part coordinate system 40, the origin of which may be located at a center of the part or based on an important feature 16 of the part. Individual features, such as illustrated by the third cavity 30, may specific coordinate systems, such as a feature coordinate system 42. The part coordinate system 40 may also be referred to as a global coordinate system, because it is associated with all of the features 16.

The global offset may adjust the positions of all of the first cavity 26, the second cavity 28, and the third cavity 30 in the workpiece 12 and relative to the manufacturing tool 14. In this regard, the global offset may be similar to a rigid body shift or rotation relative to the entire workpiece 12 and the part coordinate system 40.

A local offset, however, may selectively adjust a single feature 16 or group of features 16 by modifying the nominal dimensions and positioning of the manufacturing tool 14 for only that specific feature or group of features. As shown in FIG. 2, some of the first cavity 26, the second cavity 28, and the third cavity 30 may have nominal positions defined relative to their local centers or coordinate systems, which may in-turn be positioned relative to the machine coordinate system 38. Therefore, the local offset may adjust the nominal position of local centers within the machine coordinate system 38, without affecting other features.

Even though the global offset is a rigid body motion, it can adjust the workpiece coordinate system to an optimal place so that the feature deviations are minimized. One type of deviation that may require correction may result from elastic deformation during the machining process. For example, if the workpiece 12 is not sufficiently rigid to resist clamping forces and/or cutting tool pressure during the machining process, the workpiece 12 may elastically deform during certain machining processes. Once the forces are removed, the workpiece 12 may return to an un-deformed state and shift any feature that was machined while the part was deformed.

The global offset calculated by the compensation processor 20 may provide a median correction so that the total part deviations are minimized. An exemplary metric representing the total part deviation may include the standard deviation of the difference between each measured dimension and its respective provided nominal dimension. There may, however, be a residual deviation that remains after the global offset adjustment is applied. The residual deviation may not be acceptable for features with a tight tolerance. Implementation of the local offset may allow the deviation of that particular feature 16 to be adjusted (i.e., during machining) so that it is accurately positioned once any elastic loading is removed. The local offset applies only to a specific feature 16 or a group of specific features 16.

Additional discussion and description of global and local offsets may be found in U.S. Pat. No. 8,509,940, issued Aug. 13, 2013, and in U.S. patent application Ser. No. 15/093,032, filed Apr. 7, 2016, both of which are hereby incorporated by reference in their entirety.

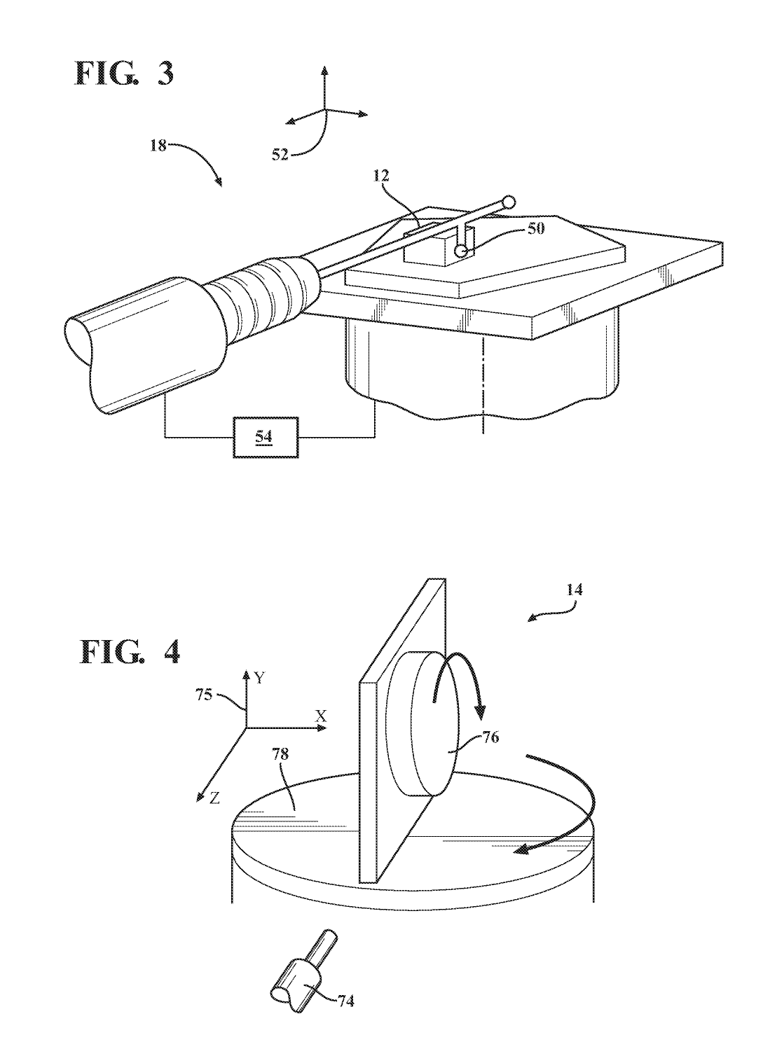

FIG. 3 illustrates an embodiment of the CMM 18, which may be used as the dimensional measuring device for the methods described herein. The CMM 18 may include a probe 50 that may be numerically located in a three-dimensional CMM coordination system 52 by a measurement processor 54. The probe 50 may be moved into physical contact with the workpiece 12, at which time the measurement processor 54 may record a three-dimensional position. By comparing multiple recorded positions, the measurement processor 54 may report one or more distances or dimensions of machined workpieces created to match the workpiece 12. Alternatively, an optical or laser dimensional measuring device may measure and report dimensions of machined workpieces created by the manufacturing system.

The CMM 18 reports, records, or outputs measurement data that is usable by the compensation processor 20. Using the methods described herein, the compensation processor 20 determines global and local offsets that are communicated as compensation variables 24 and used to electronically compensate the manufacturing tool 14.

Referring also to FIG. 4, and with continued reference to FIGS. 1-3, there is illustrated one embodiment of the manufacturing tool 14, which may generally be referred to as a 5-axis A-on-B type CNC machine or mill. Note that other embodiments of the manufacturing tool 14 may be used with the methods and techniques described herein.

In the configuration of the manufacturing tool 14 shown in FIG. 4, a cutting spindle 74 is capable of three degrees of translation relative to an illustrative x-y-z coordinate system 75. An A-table 76 sits on a B-table 78, and the workpiece 12 may be fixed, such as with a figured (not shown) to the A-table 76. Rotation of either the A-table 76 or the B-table 78 may be considered rotation about a first axis or a second axis.

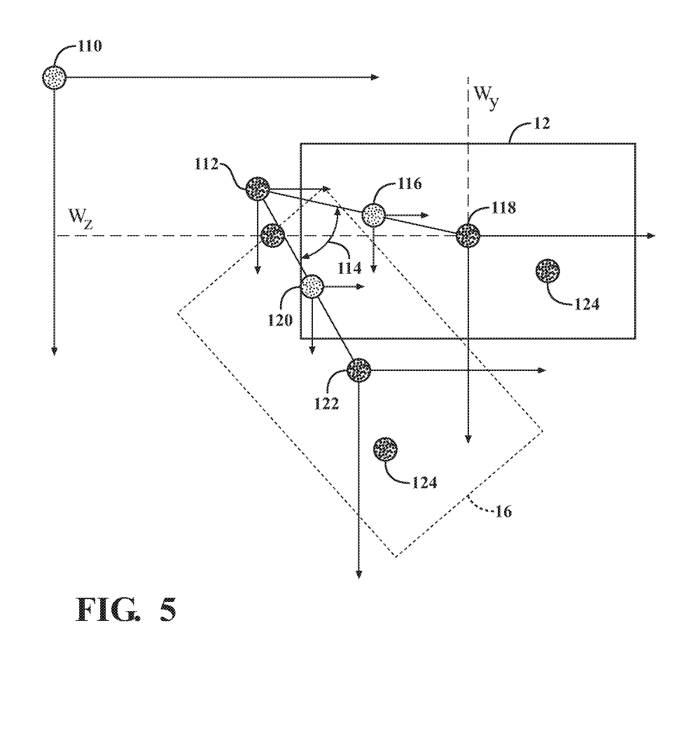

Referring also to FIG. 5, and with continued reference to FIGS. 1-4, there is shown a schematic illustration of several coordinate systems, and adjustments thereof. Note that although the methods and techniques described herein are applicable to a three-dimensional system, FIG. 5 is simplified to a two-dimensional system.

As illustrated in FIG. 5, the manufacturing tool 14 may have a native, independent coordinate system, which may be referred to as machine system 110, absolute machine system M, or simply M system. The machine system 110 of the manufacturing tool 14 may be a stationary coordinate system with its origin as the machine home and its positive directions set as the machine way directions. Furthermore, in the configuration shown, the CMM 18 may record each measurement as GD&T (geometric dimensioning and tolerancing) values aligned with an arbitrary CMM coordinate system (not separately shown).

In FIG. 5, the origin of a table coordinate system, which may be referred to as table system 112 or simply T system, is shown within the machine system 110. The table system 112 may be aligned on the rotational center of one of the machine tables, such as either the A-table 76 or the B-table 78 shown in FIG. 4. The origin of the table system 112 may be translated a distance from the origin of the machine system 110, and may be orientated in a similar manner as the machine system 110. The table may be capable of rotating about the table center (i.e., the origin of the table system 112) through a variable angle 114.

In many configurations, a fixture may be positioned on the machine table and used to locate and restrain the workpiece 12. The fixture may have a corresponding fixture coordinate system, which may be referred to as fixture system 116 or F system, that is located at the center of the fixture. The fixture system 116 may be translated a distance from the table center, though it may also be oriented in a similar manner as the machine system 110 and the table system 112.

The workpiece 12 may be rigidly, or substantially rigidly, clamped to the fixture. The workpiece 12 may have a corresponding part coordinate system, which may be referred to as part system 118 or P system. The part system may be located at the center of the workpiece 12, or may be located at a specific feature of the workpiece 12, and may be aligned with the machine system 110.

In an embodiment, the origin of the part system 118 may be translated a distance from the origin of the fixture system 116. As the machine table rotates about its center through the variable angle 114, the fixture and the workpiece 12 will similarly rotate about the table center. As illustrated, following rotation, the origin of the fixture system 116 (i.e., the fixture center) will assume a new fixture position 120, within the machine system 110. Similarly, the origin of the part system 118 (i.e., the part center) will assume a new part position 122. However, the orientation of the part system 118, the fixture system 116, and the table system 112 (i.e., the P, F, and T systems) may remain aligned with the orientation of the machine system 110, as illustrated in FIG. 5. The part system 118 may also be referred to as the global coordinate system.

Using these exemplary relationships, Equation 2 may be used to define the origin of the part system 118 (e.g., the part center) within the machine system 110. The “W” values in Equation 2 are the workpiece coordinate locations that define the origin of the part system 118 within the machine system 110.

$$\{ \begin{matrix}Wx = ( {Tx}_{B} ) + ( {Tx}_{A} + {Px}_{0} ) cos B - \\ [ ( {Tz}_{A} ) - ( {Py}_{0} ) sin A + ( {Pz}_{0} ) cos A ] sin B \\ Wy = ( {Ty}_{B} + {Ty}_{A} ) + ( {Py}_{0} ) cos A + ( {Pz}_{0} ) sin A \\ Wz = ( {Tz}_{B} ) + ( {Tx}_{A} + {Px}_{0} ) sin B + \\ [ ( {Tz}_{A} ) - ( {Py}_{0} ) sin A + ( {Pz}_{0} ) cos A ] cos B \\ {W}_{A} = A \\ {W}_{B} = B\end{matrix} \qquad Equation 2$$

As used in Equation 2, the point (Tx_{B}, Ty_{B}, Tz_{B}) represents the nominal center of the B-table 78, as measured from the machine zero (i.e., the origin of the machine system 110).

Similarly, the point (Tx_{A}, Ty_{A}, Tz_{A}) represents the nominal center of the A-table 76, as measured from the machine zero (i.e., the origin of the machine system 110). Note that either the A-table 76 or the B-table 78 may represent the table system 112 shown in FIG. 5, as that illustration is two-dimensional. The point (Fx₀, Fy₀, Fz₀) represents the distance between the fixture center (i.e., origin of the fixture system 116) and the table center when the variable table angle B=0; and, the point (Px₀, Py₀, Pz₀) represents the distance between the part center (i.e., the origin of the part system 118) and the fixture center when table angle B=0.

A specific feature 124 may be machined into the workpiece 12 by a tool, such as the spindle 124 shown in FIG. 4. As illustrated in FIG. 5, as the workpiece 12 moves through the variable angle 114, the specific feature 124 may move within the part system 118, the fixture system 116, and the table system 112 (i.e., the P, F, and T systems), but is inherently fixed on the workpiece 12.

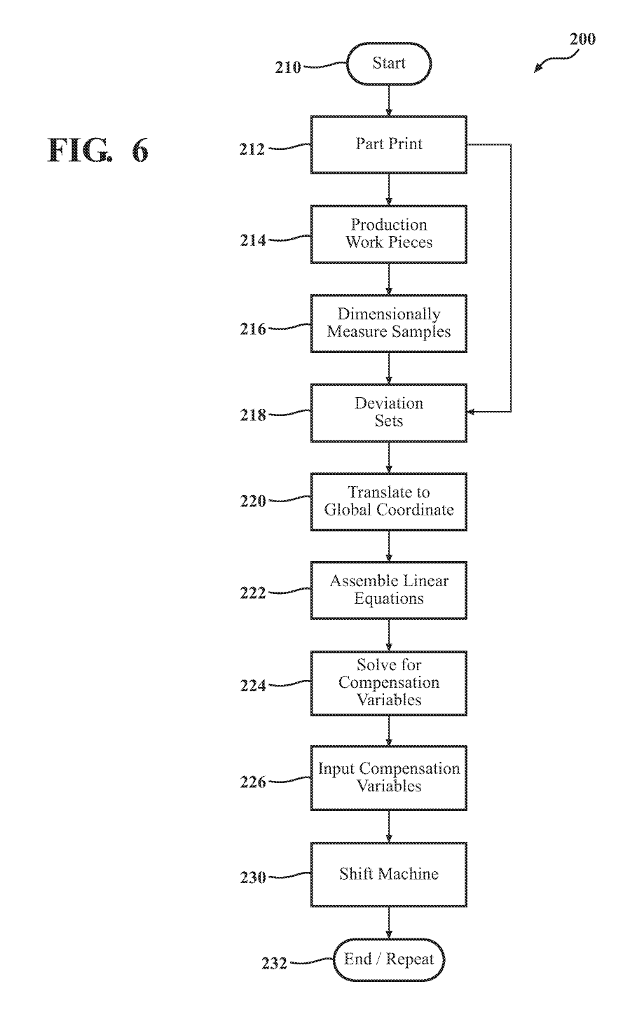

Referring also to FIG. 6, and with continued reference to FIGS. 1-5, there is shown an illustrative flowchart for a method or algorithm. FIG. 6 broadly illustrates a method 200 for compensating a controllable manufacturing system, such as the manufacturing tool 14, having at least five axes of movement or freedom. Portions of the system 10 or other computer-controlled systems may execute the method 200. While operation of the method 200 is illustrated herein with reference to components, systems, methods, and techniques described herein relative to the figures, other manufacturing systems may utilize the method 200.

Step 210: Start.

The method 200 may begin at a start or initialization step, during which time the method 200 is made active. The method 200 may be running or looping constantly or may be executed only when needed.

Step 212: Load Part Characteristics.

In order to produce workpieces 12 representing the desired part, the method 200 includes loading or inputting characteristics of the part. For example, the part print may be communicated to the manufacturing tool 14, the CMM 18, and the compensation processor 20. Note that the part print is likely three-dimensional. Loading part characteristics may include translating the part print into G-Code for the manufacturing tool 14 and converting dimensions of the part into the native coordinate system of the CMM 18.

Step 214: Produce Workpieces.

The method 200 includes producing one or more workpieces 12 with the manufacturing tool 14 based on the part print. Therefore, each resulting workpiece 12 includes the plurality of part features 16 based on a plurality of nominal dimension sets from the part print.

Step 216: Dimensionally Measure Workpieces.

The method 200 includes measuring one or more of the part features 16 of one or more workpieces 12 with a dimensional measuring device, such as the CMM 18. In some configurations, each workpiece 12 produced may be submitted for measurement by the CMM 18.

However, in other configurations, only selected workpieces 12 will be subjected to measurement. The measured workpieces 12 will be used as representative samples of the operations of the manufacturing device 14. The measured workpieces 12 may be selected at random, selected based on shifts schedules, or chosen at statistically-selected intervals.

Step 218: Derive Deviation Sets.

The method 200 includes deriving a plurality of deviation sets from differences between the measured part features 16 and the nominal dimension sets in the part print. From the measurements taken in the CMM 18, the compensation processor 20 or the CMM 18, itself, determines deviations relative to the part print.

These deviation sets represent an inability of the manufacturing tool 14 to produce workpieces 12 within the dimensional tolerances of the part print. As discussed above, these errors may be addressed through mechanical adjustment or electronic compensation. The x-direction deviation for a given dimension may be expressed as ΔX_{cmm}, which is equal to the difference between the nominal dimension and the measured dimension, such that: ΔX_{cmm}=Xₙₒₘᵢₙₐₗ−X_{cmm}. The full deviation set would generally include ΔX, ΔY, and ΔZ components, based on similar differentials (i.e., ΔZ_{cmm}=Zₙₒₘᵢₙₐₗ−Z_{cmm}, and ΔY_{cmm}=Yₙₒₘᵢₙₐₗ−Y_{cmm}.). Note, however, that even though the manufacturing tool 14, such as many of those illustrated herein, likely includes more than one axis of rotation, the CMM 18 generally measures only linear dimensions, such that the deviation sets include only linear deviations.

Step 220: Translate Deviations to Part or Machine Coordinate System.

The CMM 18 may determine the deviation sets relative to a coordinate system that is native to the CMM 18. Therefore, the method 200 may include translating each of the deviation sets for the measured part features 16 to a common coordinate system of either the part print or the manufacturing tool 14, if the deviations are not initially derived in such system.

For example, the deviation sets may be translated into, for example, either the machine coordinate system 38 or the part coordinate system 40 of FIG. 2 or the machine system 110 or the part system 118 of FIG. 5. In some configurations, the CMM 18 may utilize the part system 118 is its base coordinate system, such that the deviation sets are calculated directly with reference to the part system 118 and less translation is needed.

Step 222: Assemble Linear Equations.

The method 200 includes assembling or creating linear equations that equate the deviation sets for the measured part features 16 to the plurality of compensation variables 24. Equation 3 shows three such linear equations, one for each component of the deviation set (on the right side of Equation 3).

$$Equation 3$$

$$\{ \begin{matrix}cos B Δ {Tx}_{B} + sin B Δ {Tz}_{B} + Δ {Px}_{0} + [ {Tz}_{A} - ( {Fy}_{0} + {Py}_{0} + {Y}_{cmm} ) sin A + \\ ( {Fz}_{0} + {Pz}_{0} + {Z}_{cmm} ) cos A ] Δ B = - Δ {X}_{cmm} \\ cos A Δ {Ty}_{A} - sin A Δ {Tz}_{A} + sin A sin B Δ {Tx}_{B} - sin A cos B Δ {Tz}_{B} + Δ {Py}_{0} - \\ ( {Fz}_{0} + {Pz}_{0} + {Z}_{cmm} ) Δ A + ( {Tx}_{A} + {Fx}_{0} + {Px}_{0} + {X}_{cmm} ) sin A Δ B = - Δ {Y}_{cmm} \\ sin A Δ {Ty}_{A} + cos A Δ {Tz}_{A} - cos A sin B Δ {Tx}_{B} + cos A cos B Δ {Tz}_{B} + Δ {Pz}_{0} + \\ ( {Fy}_{0} + {Py}_{0} + {Y}_{cmm} ) Δ A - ( {Tx}_{A} + {Fx}_{0} + {Px}_{0} + {X}_{cmm} ) cos A Δ B = - Δ {Z}_{cmm}\end{matrix}$$

There are nine compensation variables 24 (each beginning with a Δ on the left side of Equation 3). Therefore, the compensation variables in this illustrative example are: ΔTx_{B}, ΔTz_{B}, ΔPx₀, ΔB; ΔTy_{A}, ΔTz_{A}, ΔPy₀, ΔA; and ΔPz₀.

In the configuration shown, Equation 3 solves for the negative direction of the deviation sets. However, other linear equations may be oriented differently.

Step 224: Solve for Compensation Variables.

The method 200 may create numerous deviation sets, one or more for each of the measured features 16, such that there may be hundreds of the linear equations illustrated by Equation 3. Therefore, the system results in more equations than unknowns. The method 200 solves the linear equations to determine the nine compensation 24 variables shown in Equation 3.

In some configurations, the method 200 uses a least square fit solution to solve the equations for the compensation variables. With the least squares fit solution, the method 200 minimizes the sum of the squares of the errors made in the results of the equations established in step 222. Least squares is, however, only one possible method for solving equations having more solutions than unknowns, and any suitable technique may be used with the method 200.

Step 226: Input Compensation Variables to Machine.

The method 200 transfers or inputs the calculated compensation variables to the computer controlled manufacturing tool 14. Registers are built into the fixed G-code programming of the manufacturing tool 14, such that the compensation variables may be incorporated into operation of the manufacturing tool 14 without altering fixed G-code programming.

The shifted workpiece coordinate system is shown below in Equation 4, and includes the nine compensation variables 24—each of which is preceded by a Δ on the right side of the individual equations—solved for by the compensation processor. The shifted W values may be entered through the registers in the G-Code programming of the manufacturing system 10.

$$Equation 4$$

$$\{ \begin{matrix}Wx = ( {Tx}_{B} + Δ {Tx}_{B} ) + ( {Tx}_{A} + {Px}_{0} + Δ {Px}_{0} ) cos B - \\ [ ( {Tz}_{A} + Δ {Tz}_{A} ) - ( {Py}_{0} + Δ {Py}_{0} ) sin A + ( {Pz}_{0} + Δ {Pz}_{0} ) cos A ] sin B \\ Wy = ( {Ty}_{B} + {Ty}_{A} + Δ {Ty}_{A} ) + ( {Py}_{0} + Δ {Py}_{0} ) cos A + \\ ( {Pz}_{0} + Δ {Pz}_{0} ) sin A \\ Wz = ( {Tz}_{B} + Δ {Tz}_{B} ) + ( {Tx}_{A} + {Px}_{0} + Δ {Px}_{0} ) sin B + \\ [ ( {Tz}_{A} + Δ {Tz}_{A} ) - ( {Py}_{0} + Δ {Py}_{0} ) sin A + ( {Pz}_{0} + Δ {Pz}_{0} ) cos A ] cos B \\ {W}_{A} = A + Δ A \\ {W}_{B} = B + Δ B\end{matrix}$$

Step 230: Electronically Shift Machine.

The method 200 includes shifting a position of the manufacturing system 10 by the solved compensation variables. In particular, the method 200 may shift a location of the coordinate system representing the workpiece 12 within the machine coordinate system based on the solved compensation variables, as shown in Equation 4.

By electronically shifting coordinates of the manufacturing tool, resulting manufacturing operations performed by the manufacturing tool 14 are physically shifted or offset relative of the actual workpieces 12 produced following the shift. For example, in a basic situation, where the linear equations may have determined that one of the compensation variables, the x-value of the table system 112, was off by 0.01 inches. The result of the electronic shift of the manufacturing tool 14 would be to account for such deviation and move the physical machining processes in the opposite direction relative to the table system 112. The manufacturing tool 14 therefore improves manufacturing operations based on the compensation variables, and does so without altering fixed G-code programming of the manufacturing tool 14.

Step 232: End/Repeat.

The method 200 may end or may repeat, immediately, or in the future.

Referring also to FIGS. 7A-7D, and with continued reference to FIGS. 1-6, there are illustrated several versions of computer controlled manufacturing systems or manufacturing tools upon which the methods and techniques described herein may be implemented. These exemplary systems are utilized in a similar fashion as the 5-axis, A-on-B CNC mill shown in FIG. 4, and may have the method 200 or similar algorithms or processes applied thereto. The systems shown in FIGS. 7A-7D are only be described in a cursory fashion.

FIG. 7A shows a schematic illustration of a 6-axis machine 310, which is an A-on-B table CNC mill with a rotatable spindle. The 6-axis machine 310 shown has a cutting spindle 324 that is capable of three degrees of translation relative to an illustrative x-y-z coordinate system 325. The workpiece, and any associated fixture, may be located on an A-table 326, which sits on a B-table 328. Furthermore, unlike the manufacturing tool 14 shown in FIG. 4, the cutting spindle 324 is capable of moving or rotating about a spindle-A axis 330.

FIG. 7B shows a schematic illustration of a 7-axis machine 360, which is a C-on-B table CNC mill with a spindle rotatable about two axes. The 7-axis machine 360 shown has a cutting spindle 374 that is capable of three degrees of translation relative to an illustrative x-y-z coordinate system 375. The workpiece, and any associated fixture, may be located on a C-table 376, which sits on a B-table 378. In the illustrative 7-axis machine 360, the cutting spindle 374 is cable of moving or rotating about a spindle A-axis 380 and also about a spindle B-axis 382.

FIG. 7C shows a schematic illustration of a 6-axis machine 410, which is a lathe mill having a two-axis spindle. A workpiece 412 is rotatable relative to a cutting spindle 424, and may be held with a collet 416. The cutting spindle 424 is capable of three degrees of translation relative to an illustrative x-y-z coordinate system 425. The cutting spindle 424 is also cable of moving or rotating about a spindle A-axis 430 and also about a spindle B-axis 432.

FIG. 7D shows a schematic illustration of a multi-axis robot 460. While other configurations of machines usable with method 200 have been illustrated as mills or other machines removing material, the multi-axis robot 460 may also be used for additional processes, in addition to cutting. For example, and without limitation, the multi-axis robot 460 may be used for welding, fastening, or positioning workpieces relative to one another.

The method 200 may be used with other computer controlled machines or machining systems that are not shown. Such systems include, without limitation: gear machining systems; wobble broaching systems; and grinding systems. Note that method 200 can be applied to systems having additional, or different, axes of freedom relative to those shown in the figures.

While some of the best modes for carrying out the disclosed methods, processes, and structures have been described in detail, those familiar with the art to which the disclosed methods, processes, and structures relate will recognize various alternative designs and embodiments for practicing the disclosure within the scope of the appended claims. All directional references (e.g., upper, lower, upward, downward, left, right, leftward, rightward, above, below, vertical, and horizontal) are only used for identification purposes to aid the reader's understanding of the present disclosure, and do not create limitations, particularly as to the position, orientation, or use of the disclosed methods, processes, and structures. It is intended that all matter contained in the above description or shown in the accompanying drawings shall be interpreted as illustrative only and not as limiting.

1. A machining system, comprising:
a multi-axis machining device configured to produce a workpiece based on a part print outlining nominal dimensions for the workpiece;
a dimensional measuring device configured to take measured dimensions of the workpiece; and
a compensation processor configured to:
compare the measured dimensions to the nominal dimensions and to determine a plurality of deviation sets therefrom; and
transfer the deviation sets to the multi-axis machining device,
wherein the multi-axis machining device shifts a machine coordinate system based on the deviation sets.

2. The machining system of claim 1, further comprising:
wherein the compensation processor calculates a plurality of compensation variables from the deviation sets, and transfers the compensation variables to the multi-axis machining device, and
wherein the multi-axis machining device shifts the machine coordinate system based on the compensation variables.

3. The machining system of claim 2,
wherein the compensation processor is configured to transfer the compensation variables to the multi-axis machining device via registers in G-Code programming of the multi-axis machining device.

4. The machining system of claim 3, wherein there are at least nine compensation variables.

5. A method for compensating a controllable manufacturing system having at least five axes of movement, comprising:
producing a workpiece with the manufacturing system based on a part print, such that each workpiece includes a plurality of part features based on a plurality of nominal dimension sets in the part print;
measuring the part features with a dimensional measuring device;
deriving a plurality of deviation sets from differences between the measured part features and the nominal dimension sets in the part print;
creating linear equations that equate the deviation sets for the measured part features to a plurality of compensation variables;
solving the linear equations for the compensation variables; and
shifting a position of the manufacturing system by the solved compensation variables.

6. The method of claim 5, wherein the linear equations solved are:
$$\{ \begin{matrix}cos B Δ {Tx}_{B} + sin B Δ {Tz}_{B} + Δ {Px}_{0} + [ {Tz}_{A} - ( {Fy}_{0} + {Py}_{0} + {Y}_{cmm} ) sin A + \\ ( {Fz}_{0} + {Pz}_{0} + {Z}_{cmm} ) cos A ] Δ B = - Δ {X}_{cmm} \\ cos A Δ {Ty}_{A} - sin A Δ {Tz}_{A} + sin A sin B Δ {Tx}_{B} - sin A cos B Δ {Tz}_{B} + Δ {Py}_{0} - \\ ( {Fz}_{0} + {Pz}_{0} + {Z}_{cmm} ) Δ A + ( {Tx}_{A} + {Fx}_{0} + {Px}_{0} + {X}_{cmm} ) sin A Δ B = - Δ {Y}_{cmm} \\ sin A Δ {Ty}_{A} + cos A Δ {Tz}_{A} - cos A sin B Δ {Tx}_{B} + cos A cos B Δ {Tz}_{B} + Δ {Pz}_{0} + \\ ( {Fy}_{0} + {Py}_{0} + {Y}_{cmm} ) Δ A - ( {Tx}_{A} + {Fx}_{0} + {Px}_{0} + {X}_{cmm} ) cos A Δ B = - Δ {Z}_{cmm}\end{matrix}$$
wherein:
A is an angle of an A-table and B is an angle of a B-table,
Tx_{B}, Ty_{B}, Tz_{B} are dimensions to the nominal center of the B-table relative to the manufacturing system,
Tx_{A}, Ty_{A}, Tz_{A} are dimensions to the nominal center of the A-table 126 relative to the manufacturing system,
Fx₀, Fy₀, Fz₀ are dimensions to a center of a fixture to which the workpiece is mounted, when B is zero,
Px₀, Py₀, Pz₀ are dimensions to a center of the workpiece when B is zero,
X_{cmm}, Y_{cmm}, Z_{cmm} are dimension of at least one part feature measured by the dimensional measuring device,
ΔX_{cmm}, ΔY_{cmm}, ΔZ_{cmm} are the deviation sets applied as knows, and
ΔTy_{A}, ΔTz_{A}; ΔTx_{B}, ΔTz_{B}; ΔPx₀, ΔPy₀, ΔPz₀; and ΔB, ΔA are the nine compensation variables solved for.

7. The method of claim 6, further comprising: wherein shifting the position of the manufacturing system by the solved compensation variables includes shifting a workpiece coordinate system to Wx, Wy, Wz, W_{A}, and W_{B}, as determined by the equations:
$$\{ \begin{matrix}Wx = ( {Tx}_{B} + Δ {Tx}_{B} ) + ( {Tx}_{A} + {Px}_{0} + Δ {Px}_{0} ) cos B - \\ [ ( {Tz}_{A} + Δ {Tz}_{A} ) - ( {Py}_{0} + Δ {Py}_{0} ) sin A + ( {Pz}_{0} + Δ {Pz}_{0} ) cos A ] sin B \\ Wy = ( {Ty}_{B} + {Ty}_{A} + Δ {Ty}_{A} ) + ( {Py}_{0} + Δ {Py}_{0} ) cos A + \\ ( {Pz}_{0} + Δ {Pz}_{0} ) sin A \\ Wz = ( {Tz}_{B} + Δ {Tz}_{B} ) + ( {Tx}_{A} + {Px}_{0} + Δ {Px}_{0} ) sin B + \\ [ ( {Tz}_{A} + Δ {Tz}_{A} ) - ( {Py}_{0} + Δ {Py}_{0} ) sin A + ( {Pz}_{0} + Δ {Pz}_{0} ) cos A ] cos B \\ {W}_{A} = A + Δ A \\ {W}_{B} = B + Δ B\end{matrix}$$

8. The method of claim 7, wherein solving the linear equations for the compensation variables includes applying a least squares fit method.
